(19) United States
(12) Patent Application Publication
(10) Pub. No.: US 2004/0221673 A1
(43) Pub. Date: Nov. 11, 2004

(54) Traveling mechanism for an overhanging working device, especially for a building crane

(76) Inventor: Karel Mojzis, Neufahrn (DE)

Correspondence Address: BANNER & WITCOFF, 1001 G STREET N W, SUITE 1100, WASHINGTON, DC, 20001, US

(21) Appl. No.: 10/148,598

(22) PCT Filed: Nov. 30, 2000
(86) PCT No.: PCT/EP00/12054

(30) Foreign Application Priority Data
Dec. 6, 1999 (DE) 199 58 691.8

(51) Int. Cl. G05G 1/00

(52) U.S. Cl. 74/469

(57) ABSTRACT

According to the invention a travelling mechanism for overhanging working devices, especially for a building crane, comprising a chassis on which the working device can be mounted or is mounted and which is provided with at least one wheel axle or wheels. This travelling mechanism is designed in such a way that

(a) during manoeuvring the working device can be horizontally turned with regard to the at least one wheel axle and can be fixed with regard to the chassis in two or more different turning positions,

and/or

(b) a plurality of wheel axles which can be steered independently of one another are provided on the chassis.

The invention relates to a travelling mechanism with a chassis which is provided with at least one wheel axle and wheels and on which a working device is mounted which is horizontally overhanging at least in the transport position, so that it has a large overhang beyond the point of gravity of the travelling mechanism, as a result of which the manoeuvrability of the working device positioned on the travelling mechanism in the transport position is difficult or impossible at the place of erection under confined conditions. Such a working device is for example a building crane, such as a bottom slewing building crane, for which the travelling mechanism according to the invention is especially suitable.

One of the problems which occurs with these kinds of overhanging working devices, such as building cranes, if they are transported by means of a travelling mechanism to the place of erection, is due to the fact that on account of the relatively very long length of such a building crane in its retracted state on the travelling mechanism it is extremely difficult and in many cases even impossible to manoeuvre the building crane on the construction site due to the limited space available at the exact place of erection.

A travelling mechanism for an overhanging working device, especially for a building crane, preferably a bottom slewing building crane which enables overhanging working devices such as building cranes to be manoeuvred reasonably well under relatively confined conditions at the place of erection is disclosed in the German Patent DE 198 56 593 A1. This travelling mechanism includes a chassis with a double or tandem axle which has a first and second axle; and a coupling system connectable with a towing vehicle, whereby the chassis and the coupling system are designed in such a way that both the wheels of the first axle and the wheels of the second axle are provided with bogie or axle pivot steering, as well as the bogie or axle pivot steering of the wheels of the first axle being connected with the bogie or axle pivot steering of the wheels of the second axle in such a way that the wheels of the first and the second axle are synchronously steered in a geometric way, whereby the wheels of the first and second axle are preferably arranged within the perimeter of the support area of the working device, preferably the crane, and whereby the coupling system is designed separately from the chassis and can be mounted on the working device to be transported on the chassis and connected with the chassis to a structural unit, especially a crane, preferably a building crane, and through it can be connected with the travelling mechanism. Therefore that part to which a towing vehicle is coupled whenever the travelling mechanism is driven overland with the working device, especially the building crane, in the retracted state and then manoeuvred on the intended construction site or similar onto the place of erection is designated as coupling system.

In spite of this relatively favourable advantageous design for manoeuvring a building crane onto the place of erection under confined conditions, again and again the conditions under which building cranes have to be erected are so very constricted that a significant improvement in the manoeuvring capabilities is generally desirable. FR-A-2 750 411 in its figures as well as especially on Page 3, Lines 13-21 discloses:

(a) a travelling mechanism for a building crane with a chassis on which the building crane is mounted and which is provided with at least one wheel axle whereby,

(b) the building crane during manoeuvring can be horizontally turned with regard to the at least one wheel axle as a result of this wheel axle being turned and

(c) a plurality of wheel axles which can be steered independently from one another are provided on the chassis.

The above statements regarding DE 198 56 593 A1 also apply for this building crane with regard to manoeuvring onto the place of erection under confined conditions.

Finally a controllable stop is known from U.S. Pat. No. 3,664,515 which is especially suitable for cranes or similar for use as an anchoring stop and which serves to prevent a vehicle on which the crane is positioned toppling over due to the fact that while the crane under load is being used for the intended purpose the crane outrigger extended to a pre-determined length causes the vehicle to topple over through uncontrolled turning of the crane. For this purpose the base plate of the crane, rotatable around its axis, is surrounded by a toothed ring on which this base plate can be protected by the aforementioned controllable stop against uncontrolled turning of the crane under load which otherwise could lead to the vehicle with the crane toppling over as a result of the point of gravity of the crane under load being moved outside the support area of the same by the vehicle.

U.S. Pat. No. 3,664,515 therefore provides a means through which a crane under load and operating within its design parameters is prevented from uncontrolled turning and therefore toppling over with the vehicle on which it is mounted.

Terrain-handling and manoeuvrability problems cannot be taken from U.S. Pat. No. 3,664,515 and also cannot be imagined in the case of the crane shown there, since this is mounted on the flat platform of a lorry which can easily be driven to the place where the crane is used and its outriggers can be retracted in the transport position.

In contrast to this the object of the invention is to create a travelling mechanism with a chassis which is provided with at least one wheel axle and wheels on which a working device is mounted which is horizontally overhanging at least in the transport position so that it has a large overhang beyond the point of gravity of the travelling mechanism, as a result of which the manoeuvrability of the working device positioned on the travelling mechanism in the transport position is difficult or impossible at the place of erection under confined conditions which allows such working devices, especially building cranes to meet—even better than before—the conditions on the construction site such as terrain, obstacles and similar in regard to which especially the manoeuvring capabilities are significantly improved under confined to very confined conditions at the place of erection so that the use of such overhanging devices, especially building cranes, can be considerably extended as a result of these being able to manoeuvre at places of erection where until now such devices could not manoeuvre with a travelling mechanism.

This object is achieved according to the invention by a travelling mechanism with a chassis which is provided with at least one wheel axle and wheels and on which a working device is mounted, which is horizontally overhanging at least in the transport position so that it has a large overhang beyond the point of gravity of the travelling mechanism, as a result of which the manoeuvrability of the working device positioned on the travelling mechanism in the transport position is difficult or impossible at the place of erection under confined conditions, whereby

(a) the working device placed on the travelling mechanism in the transport position during manoeuvring can be horizontally turned with regard to the chassis and can be fixed with regard to the chassis in two or more different turning positions,

and/or

(b) the working device is mounted on the chassis via a double rocker which includes a lateral rocker which allows the working device to be inclined across the direction of travel and can be locked in its inclined position with regard to the longitudinal rocker.

The fact that the double rocker enables the working device to be inclined across the direction of travel allows the working device to be driven and manoeuvred with the chassis more easily on very difficult terrains.

With regard to the above feature (a) in practice surprisingly it has been shown that the manoeuvring capability is considerably improved if the overhanging working device, especially a building crane, can be horizontally turned during manoeuvring and can be fixed in several turning positions which can be changed during manoeuvring.

This can be achieved with a bottom slewing building crane due to the fact that the normal rotational locking usual in the transport position between the upper and lower base is released and a practical locking and unlocking device is provided between the upper and lower base.

It appears important to point out that this use and configuration of the rotatability between the upper and lower base is completely different from that with a bottom slewing building crane in normal operation, since the conventional use of this rotatability is limited to turning the building crane in its ready erected state in order to use the crane for the purpose for which it is designed. Up to now this rotatability was exclusively used to turn the crane in the erected state. The driving device provided for the designed purpose, which the above statements confirm, is far too inexact for use according to the invention, so that the conventional driving and locking device in general cannot be used for the purpose of turning the building crane in the erected state for manoeuvring, apart from the fact it is normally powered by two-phase or three-phase AC current.

Therefore a special device according to the invention is provided to lock and unlock the turning device between the upper and lower base of a building crane for the purpose of manoeuvring, whereby turning can be performed in the unlocked state by means of the towing vehicle, however with especially cleverly devised travelling mechanisms according to the invention it is also possible to perform this turning by means of a special, for example hydraulic, driving device.

A further aspect of the present invention consists in the fact that a plurality of steerable wheel axles can be provided on the chassis to significantly increase manoeuvring capability and indeed in addition to the turning and locking capability of the working device discussed above with regard to the chassis and/or the double rocker.

In order to achieve maximum manoeuvrability it is however recommended to provide and use a combination of the two above first mentioned measures (wheel axles which can be steered independently from one another and turning and locking capability).

The travelling mechanism according to the invention preferably also has a coupling system mentioned at the beginning in connection with the travelling mechanism according to DE 198 56 593 A1, which is designed separately from the chassis and can be mounted on the working device to be transported on the chassis and connected with the chassis to a structural unit, especially a crane, preferably a building crane, essentially of the bottom slewing type and can be also connected with the travelling mechanism. The towing vehicle, for example a semi-trailer tractor or lorry, is attached to this coupling system.

In detail a preferred embodiment of the travelling mechanism according to the invention in which the working device can be turned horizontally during manoeuvring with regard to the chassis and can be fixed in at least two different turning positions is designed so that the chassis has two or more wheel axles whereby:

(c) the wheels of the individual wheel axles are provided with bogie or axle pivot steering; and

(d) the bogie or axle pivot steering of the wheels of the individual wheel axles are connected with each other in such a way that the wheels of the wheel axles are synchronously steered in a geometric way.

A further embodiment of the travelling mechanism according to the invention in which the working device can be turned horizontally during manoeuvring with regard to the chassis and can be fixed in at least two different turning positions is distinguished by the fact that the chassis has a single wheel axle which is mounted rigidly or steerably on the chassis.

In yet another embodiment of a travelling mechanism according to the invention in which the working device can be turned horizontally during manoeuvring with regard to the chassis and can be fixed in at least two different turning positions, is designed so that the chassis has several wheel axles whereby one wheel axle or several or all wheel axles is or are mounted rigidly on the chassis, whereby non-rigid wheel axles can be coupled with synchronous steering or can be steered independently of one another.

In cases where two or more wheel axles are provided which can be steered independently from one another or are coupled with synchronous steering it is possible according to the invention that the steering of the wheel axles can be temporarily uncoupled so that they can be totally flexible if required during manoeuvring and/or that the steering can be locked when in the straight ahead directional state.

As already mentioned further above, the travelling mechanism can be designed according to the invention in such a way that the working device during manoeuvring can be horizontally turned with regard to the chassis and fixed by a mechanical drive within a predetermined angle range, whereby with this design it is preferable to provide infinitely variable turning and fixing capability. Turning capability can also be provided only through the mechanical drive and the fixing capability (locking and unlocking) can be provided by one or several special locking and unlocking device(s).

An especially cost-favourable embodiment of the invention which at the same time considerably improves manoeuvrability is distinguished by the fact that the horizontal rotatability of the building crane with regard to the chassis is provided during manoeuvring by the fact that a turning lock provided in the non-erected state of the building crane between the upper and lower base of the building crane can be released, whereby preferably the turning lock includes at least one locking pin that can be inserted in each case in openings aligned with each other or recesses in the upper and lower base.

In detail the design of this relatively simple and nevertheless highly effective embodiment can be such that the one opening is formed in a sleeve provided on the upper base which can be mounted aligned in each case with one of a number of openings or recesses in the lower base by turning the upper base with regard to the lower base. The mechanical drive mentioned can include an adjustment device, preferably to turn one or the upper base with regard to one or the lower base which can be operated from the chassis and/or a towing vehicle and/or any other position and if necessary can be locked.

The mechanical drive can be designed in various ways, in particular so that the mechanical drive includes a hydraulic, compressed air or electric motor and/or a hand crank.

If the embodiment of the invention is such that the chassis has a single axle, possibly with an additional front axle on the front part of the working device, then it is preferable that the chassis is a single axle semi-trailer or single axle central trailer, possibly with an additional front axle as a drawbar trailer.

With regard to the steering the design of the travelling mechanism according to the invention can be such that to operate the steering an hydraulic system with a hydraulic cylinder, a compressed air system with a compressed air cylinder or threaded spindles driven by a hydraulic, compressed air or electric motor and/or hand crank is or are provided.

To control the steering a hand control valve arrangement, a cable remote control and/or a radio remote control can be provided. If all three types of control mentioned are provided, the steering can be controlled both from the chassis (hand control valve arrangement) as well as away from the chassis (cable remote control) or from the towing vehicle (radio remote control).

If certain limitations are accepted the steering can also be designed so that the steering can be controlled by rods or cable controls from a semi-trailer coupling or drawbar, which is mounted in the front part of the working device. However such a design is relatively complex and requires forced steering so that no independent steering is therefore possible but in some cases may be acceptable.

In certain cases in which the chassis is multiple-axle, especially two or three axles, the design can also be such that the chassis is a multiple-axle semi-trailer or rigid drawbar trailer, possibly in each case designed with an additional front axle as drawbar trailer. In addition it is pointed out that preferably the springs of the wheel axle(s) are leaf springs or air springs, preferably in the case of multiple-axle chassis are designed as leaf springs with a rocker for displacement compensation or air springs with displacement compensation by the air springs.

Finally it appears important to point out that in the cases in which—as is normal with building cranes—a support with hydraulic cylinders to erect the working device, i.e. in this case the building crane, is provided preferably to operate the support, an operating unit connectable to the two phase or three phase mains and/or battery-powered is provided, preferably a changeover to the steering unit being provided for emergency operation, whereby apart from hydraulic check valves preferably additional mechanical locking against accidental movement of the support cylinders is provided for the hydraulic support cylinders, and the design where the hydraulic support cylinders are provided and can be controlled with a preferably automatic levelling device which in particular allows sideways levelling is especially preferred.

The above advantages and features of the invention as well as others are described in more detail and explained below by way of a few especially preferred embodiments of travelling mechanisms according to the invention with a bottom slewing building crane mounted on these, whereby it is clear that, instead of the bottom slewing building crane, also another overhanging working device, for example a rocket launch ramp can be provided if necessary with the same or similar turning device such as the turning device of a bottom slewing building crane i.e. including an upper base, a lower base and a toothed ring lying between both of these, whereby the actual working device is mounted on the upper base:

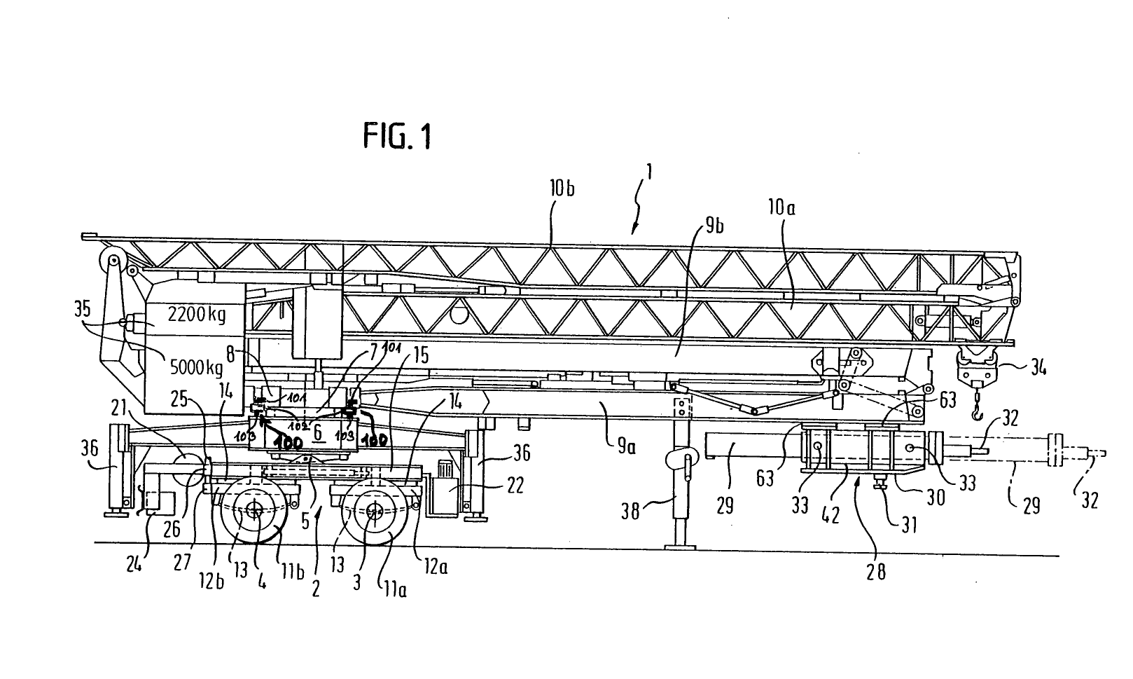

FIG. 1 shows a lateral sectional view of an embodiment of a travelling mechanism according to the invention with a bottom slewing building crane mounted on this

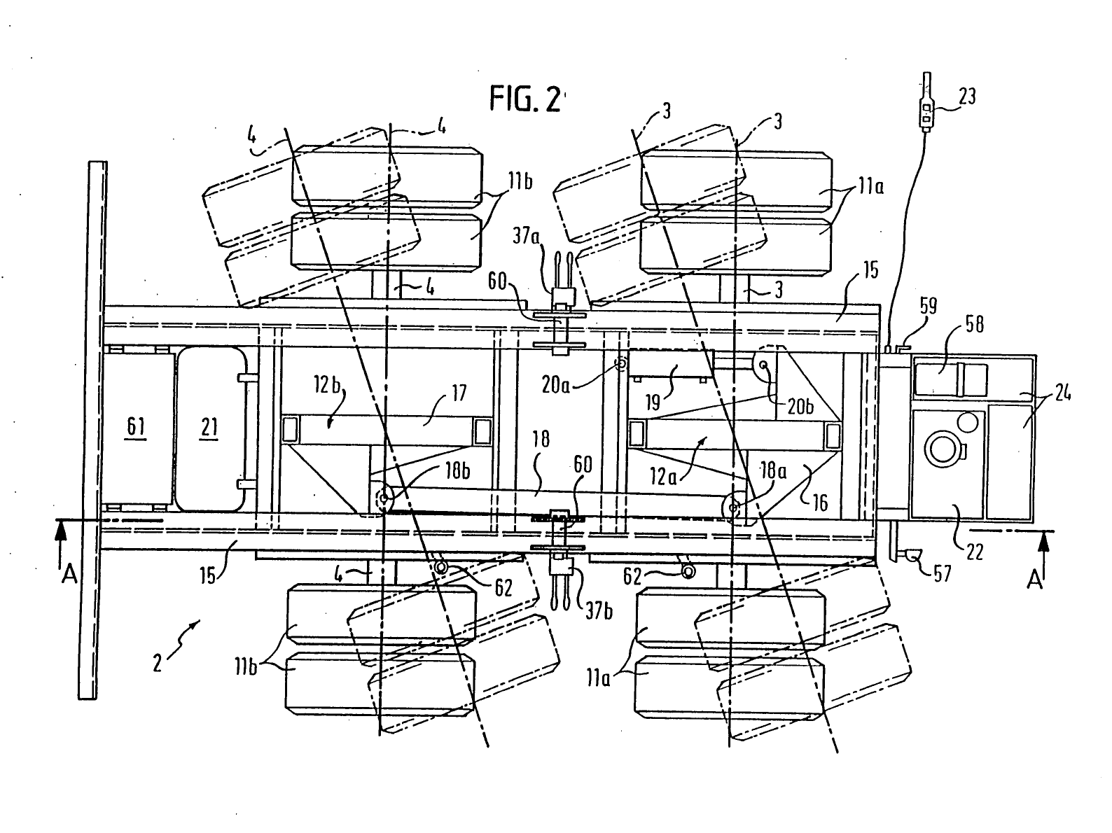

FIG. 2 shows a top view onto the embodiment of the travelling mechanism of the building crane in FIG. 1

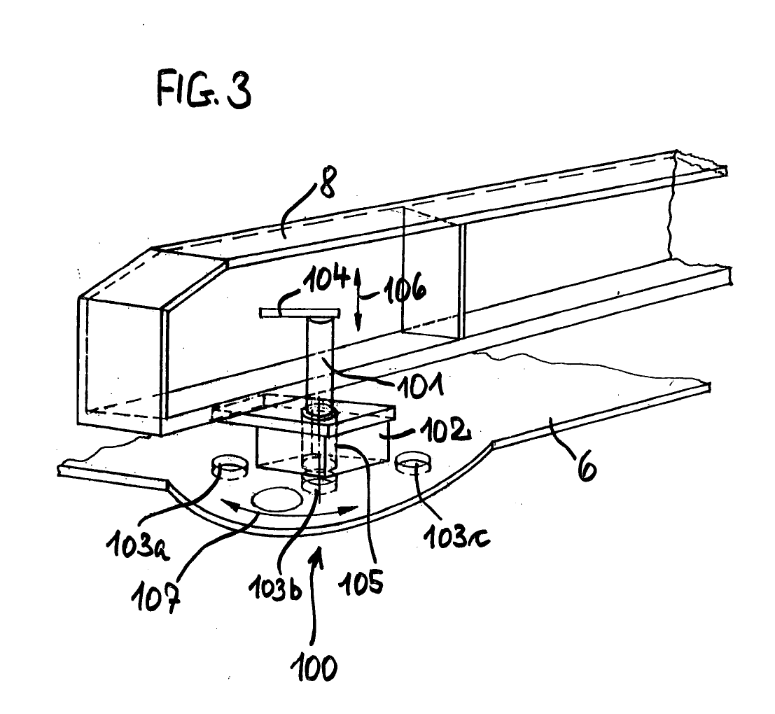

FIG. 3 shows a partial perspective view of one of the preferred several locking and unlocking devices which can be provided in the case of the chassis with a building crane according to FIG. 1 between the upper and lower base and which enable the building crane to be turned with regard to the chassis in several turning positions and to be locked and unlocked in each of these positions.

FIG. 4 shows a side view of two locking and unlocking devices of the type shown in FIG. 3.

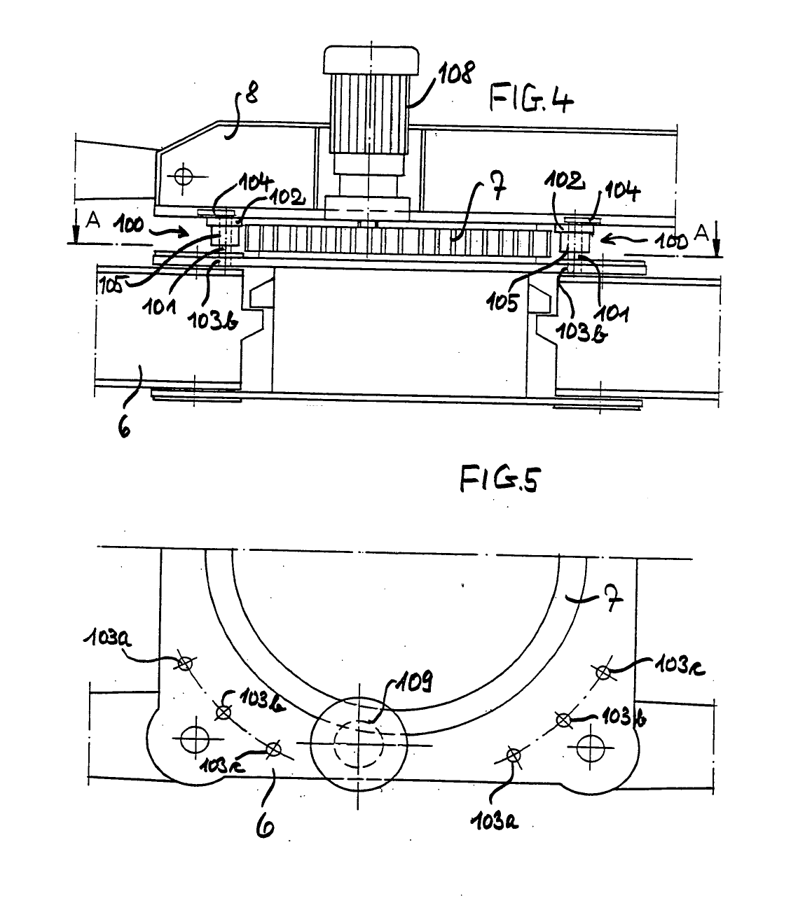

FIG. 5 shows a section along line A-A of FIG. 4.

FIG. 6 shows a lateral view of an embodiment of the invention with a single wheel axle on the chassis and with locking and unlocking devices of the type shown in FIGS. 3, 4 and 5.

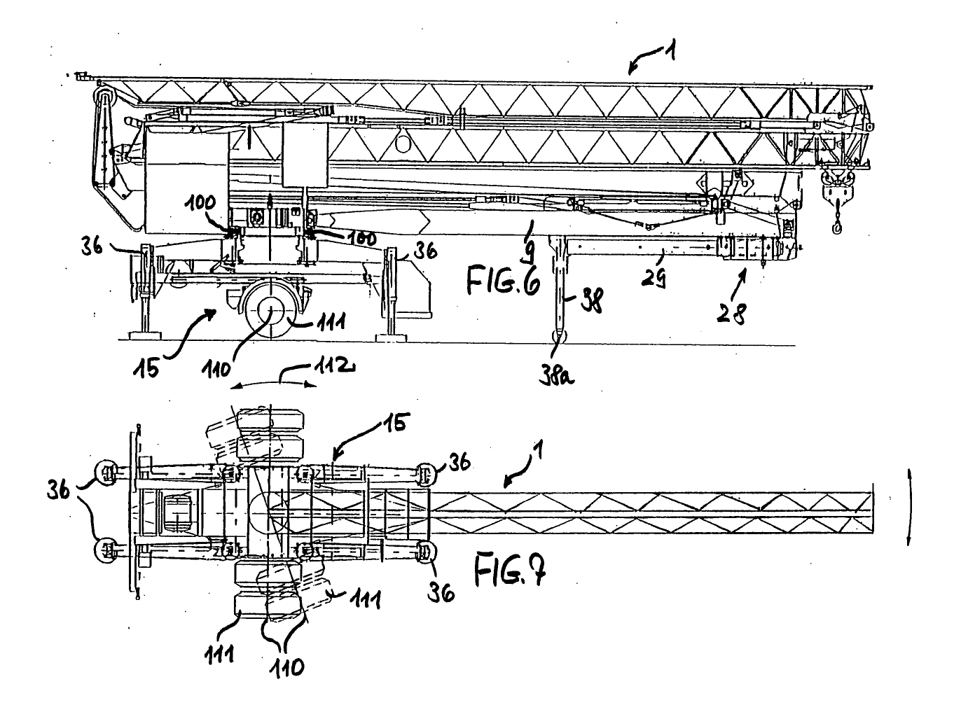

FIG. 7 shows a top view onto the embodiment according to FIG. 6 whereby parts of the crane are omitted for illustrative reasons.

FIG. 8 shows a sectional side view corresponding to FIG. 6 of another embodiment in which the chassis has two wheel axles which can be steered independently from one another and whereby if necessary locking and unlocking devices of the type shown in FIGS. 3, 4 and 5 are provided.

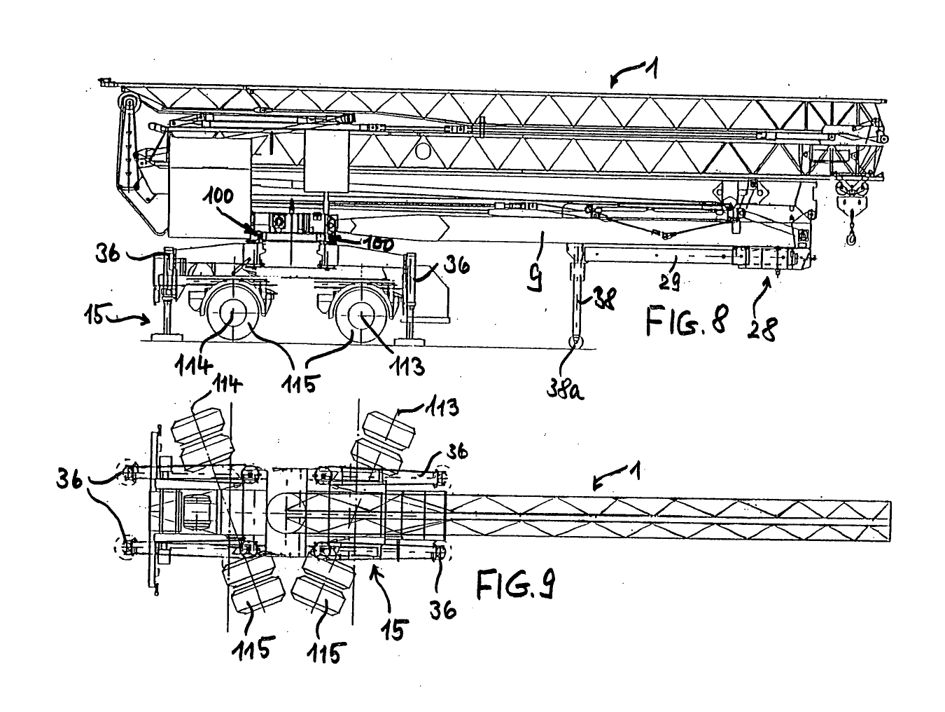

FIG. 9 shows a top view onto the embodiment of FIG. 8, which corresponds to the illustrative format of FIG. 7.

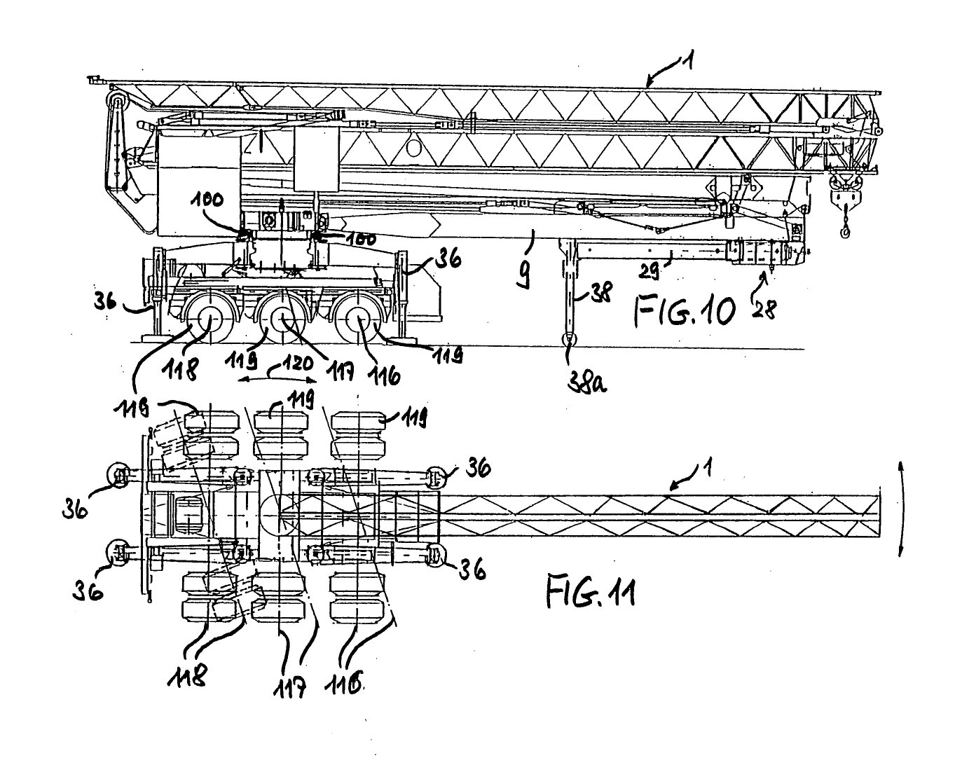

FIG. 10 shows a sectional lateral view of yet another embodiment of the invention in which the chassis is equipped with three wheel axles connected to each other with synchronous steering.

FIG. 11 shows a top view onto the embodiment of FIG. 10 corresponding to FIG. 7, which illustrates the adjustability the synchronous steering of the wheel axles.

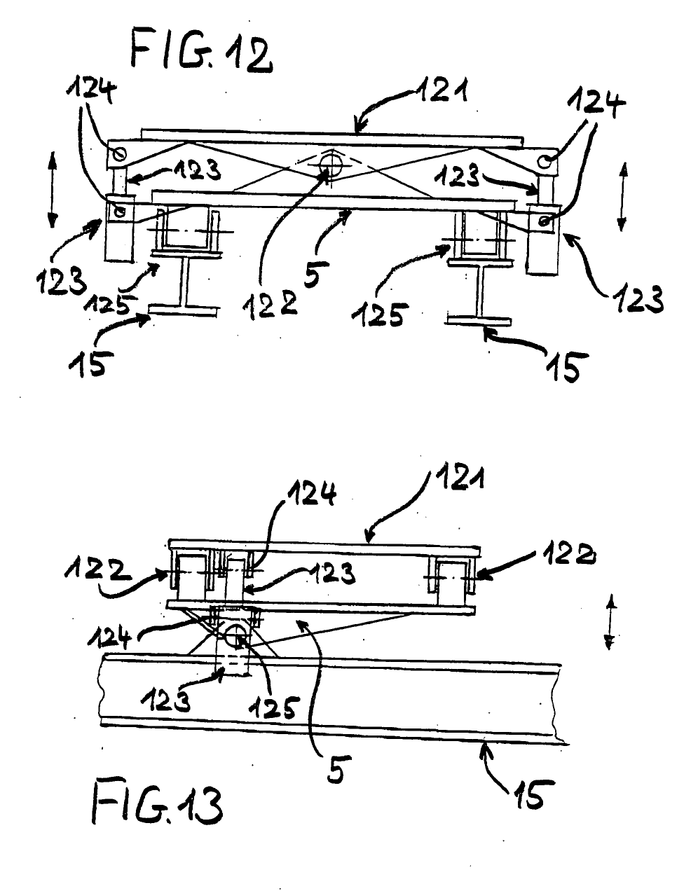

FIG. 12 shows a lateral view of the structure of a double rocker across the direction of travel and

FIG. 13 shows a lateral view of the structure of the double rocker in FIG. 12 in the direction of travel.

The complete building crane 1 shown in FIG. 1 which is designed in the present embodiment as a bottom slewing crane is provided with a travelling mechanism 2 mounted on it and which has a chassis 15 with a double or tandem axle which includes a first axle 3 and a second axle 4, whereby the first axle 3 forms the front axle in the retracted configuration of the building crane 1 according to FIG. 1 and the second axle 4 forms the rear axle. The travelling mechanism also has a coupling system 28 designed separately from the chassis 15 which is attached to the crane 1 or another working device and can be coupled to a towing vehicle.

The chassis 15 is fastened to the building crane 1 by means of a rocker 5, which has pins 60 (see FIG. 2). The building crane 1—as is normal for bottom slewing cranes—has a lower base 6, a live ring 7 and an upper base 8, whereby the crane tower 9 and the crane jib 10 are mounted on the upper base. In this case the crane tower 9 consists of a lower crane tower section 9a and an upper crane tower section 9b and the crane jib 10 has an inner crane jib section 10a and an outer crane jib section 10b. The other parts of the building crane 1 so far as they are not mentioned below are normal components and equipment of a bottom slewing crane.

The first axle 3 and the second axle 4 of the travelling mechanism 2 are in each case designed as steering axles, for the purpose of which the wheels 11 are provided with tyres in the present embodiment, specifically both the wheels 11a of the first axle 3 and the wheels 11b of the second axle 4 are equipped with bogie steering. Each bogie steering unit includes, as is clear especially from FIGS. 1 and 2, a bogie 12 on which the axle 3 or 4 is mounted via leaf springs 13 as well as a steering ring 14 which in this case is designed as a spherical steering ring and via which the associated bogie 12 is fastened to the chassis 15 of the travelling mechanism 2. Each of the two bogies 12 is equipped in each case with a connecting and reinforcing structure 16 or 17 and these two connecting and reinforcing structures 16 and 17 are connected to one another via articulated joints 18a or 18b to create a steering movement which is geometrically synchronous by a power train 18 which is configured in this case as a steering rod.

The steering can be operated hydraulically and to be precise by means of a steering or hydraulic cylinder 19 (indicated in FIG. 2 as a dotted line) which is mounted via a first articulated joint 20a on the chassis 15 and via a second articulated joint 20b on the one 16 of the two connecting and reinforcing structures 16, 17. This steering or hydraulic cylinder 19 is supplied by an hydraulic system 58 mounted on the chassis 15 and can be controlled by means of a steering- or remote-control 23, for example via a Bowden wire or electric cable. The pump not shown of the hydraulic system 58 is supplied with electric current by vehicle batteries 24, for example two 12 volt vehicle batteries. When the building crane is in operational use and therefore connected to the construction site power source, the vehicle batteries 24 are charged by a built-in battery charger. A compressed air tank for the brake system is shown with reference 21.

As a result of the above structure the steering of the first and second axle 3 or 4 can be geometrically adjusted synchronously and with the aid of this steering and in conjunction with the fact that horizontal turning of the building crane 1 in relation to the chassis 15 and locking of the same is provided in various turning positions during manoeuvring, excellent handling of the travelling mechanism according to the invention on the construction site results, and especially easy access to narrow or very narrow construction site entrances is possible.

A preferred embodiment of a locking and unlocking device to move the building crane 1 into various horizontal turning positions with regard to the chassis 15 is now explained in more detail by way of FIGS. 3, 4 and 5, whereby turning between the different positions is performed in the simplest case by means of the towing vehicle which is coupled to the coupling system 28 (see FIG. 1).

The complete locking and unlocking device shown with reference 100 has a locking pin 101 which can be moved vertically in a locking pin bracket 102 mounted on the upper base 8 and can be optionally inserted into one of several apertures 103, namely 103a, 103b or 103c which are provided in the lower base 6 so that different turning positions of the upper base 8 with regard to the lower base 6 can be achieved. For this purpose the locking pin 101 only needs in each case to be raised against the handle and simultaneous stop 104, in order to ensure rotatability by unlocking the upper and lower base, after which the turning position is changed by means of the towing vehicle until another of the apertures 103a, 103b or 103c is aligned with the locking pin 101. Afterwards the locking pin 101 is again lowered and inserted into the aperture required until the handle and stop 104 lie on the upper side of the locking pin bracket 102.

The locking pin 101 can be provided with a ratchet (not shown) or other holding device so that it remains in the upper position shown in FIG. 3 while turning or it can be extracted completely and then inserted back into its sleeve or opening 105, cylinder-shaped in this case, in the locking pin bracket 102.

The vertical locking and unlocking movement of the locking pin 101 is indicated by the double arrow 106 and the relative turning movement between the upper and lower base 6 or 8 is represented by the double arrow 107.

Naturally the invention is not limited to this embodiment but the most varied types of locking and unlocking devices can be used and preferably in each case a plurality of individual locking and unlocking devices 100 of the type shown in FIG. 3 or another type as FIGS. 1, 4 and 5 illustrate, whereby the toothed or live ring 7 is also illustrated in FIGS. 1 and 4, which is omitted for illustrative reasons in FIG. 3.

Also FIG. 4 shows the motor 108, which is provided for normal turning of the crane in the erected state, whereby the pinion 109 engaging the live or toothed ring 7, which is mounted on the shaft of the motor 108 is indicated in FIG. 5. However the motor 108, as already stated above, would be much too inexact for precise manoeuvring and is provided purely to turn the crane in the erected state, for the purpose of which it must be connected to a mains power supply.

Instead of the relative turning between the lower and upper base 6 or 8 by means of the towing vehicle, an adjustment device to turn the upper base 8 with regard to the lower base 6 can also be provided and to be precise either in addition to the locking and unlocking device(s), such as for example 100, e.g. a manual crank or if the adjustment device as such can be locked and unlocked, instead of the locking and unlocking device(s) or in addition to these. The adjustment device can for example be formed from one or several hydraulic cylinders which is or are mounted in an articulated way between the lower and upper base 6 or 8 which can be locked or unlocked by a lock valve in each case in the hydraulic path. Naturally also other adjustment devices, for example ones which can be operated by compressed air or are driven by a battery-powered electric motor can be provided.

FIGS. 6 to 11 show three different embodiments of the chassis with various wheel axles and various steering arrangments for these wheel axles:

(a) Thus a chassis 15 is shown in FIGS. 6 and 7 which only has a single wheel axle 110, which, as illustrated by the two positions of this wheel axle 110 and the associated wheels 111, is designed so that it can be steered, whereby the steering can if necessary be disconnected for special manoeuvring situations. The steering range of the wheel axle 110 is indicated by the double arrow 112. In another embodiment this wheel axle 110 can be rigid, i.e. have no steering capability.

(b) A chassis 15 is shown in FIGS. 8 and 9, having two wheel axles 113 and 114 which can be steered independently from one another with wheels 115, whereby here the steering of the wheel axles 113 and 114 can also be designed so that it can be disconnected for special manoeuvring situations.

(c ) Finally a chassis 15 is shown in FIGS. 10 and 11 having three steerable wheel axles 116, 117 and 118 with wheels 119. These axles are for example coupled in the way described above for the wheel axles 3 and 4 so that the synchronous steering can be adjusted as illustrated in FIG. 11 by the two axle positions and the double arrow 120. If necessary the design here can also be such that the steering can be disconnected for special manoeuvring situations.

Moreover reference is made to the detailed description of FIGS. 1 to 5 to explain FIGS. 6 to 11. It is simply again pointed out that an outrigger 38 with a wheel 38a is provided on the crane tower 9 in FIGS. 6 to 11 instead of the outrigger which can be supported with a plate of FIG. 1, which however can also be replaced by an outrigger 38 of FIG. 1.

In addition it is clear to the person skilled in the art that the wheel axles in the individual embodiments can be fixed in the straight directional position for transport over land.

Finally it is again pointed out that although locking and unlocking devices 100 are provided in the embodiment of FIGS. 8 and 9 for maximum manoeuvrability, these devices can also be omitted if necessary as the wheel axles 113 and 115 which can be steered independently from one another already allow excellent manoeuvrability.

Thus the steering device, as shown in FIG. 2 for example in this case so that the crane can be driven on road, can be locked in the straight directional position by a locking device 62 (see FIG. 2) and to be more precise in the illustrated embodiment by a locking pin 25 (see FIG. 1) which can be inserted in two sleeves 26 and 27 aligned with each other, of which the one sleeve 26 is rigidly mounted on the chassis 15 and the other sleeve 27 on the one of the two bogies 12a, 12b so that when the locking pin 25 is inserted, both bogies which are together shown with the reference 12, force-coupled with each other via the power train 18, are locked in the straight directional position.

The coupling system 28 (see especially FIG. 1) forms a part of the travelling mechanism 2 which is separate from the chassis 15 and is completely mounted on the building crane 1, in this case on the lower crane tower section 9a and connected by the same with the travelling mechanism 2. If instead of the crane 1 another similar overhanging working device such as for example an extremely long fire engine ladder, a long tubular structure, a rocket launch ramp or similar is equipped with the travelling mechanism 2 according to the invention, then the coupling system here is also mounted on the front end area of the working device in the direction of travel and functionally the working device forms, just like the crane 1 in this case, part of the whole “chassis” since it connects the coupling system with the travelling mechanism 2 or its chassis 15.

The coupling system 28 in the present embodiment essentially consists of a guide bar 42, a telescopic drawbar 29, a fifth wheel load plate 30 and a pin 31. The telescopic drawbar 29 is guided when pushing in and out by means of the guide bar 42 as shown in FIG. 1 where the telescopic drawbar 29 is represented by dash-dotted lines in the extracted position and by extended lines in the retracted position. On the front end of the telescopic drawbar 29 there is a towing eye 32 which is bolted on to the telescopic drawbar 29 so that the working device 1 in this preferred embodiment, i.e. the building crane shown, can be connected via the towing eye 32 with the pin coupling of a lorry. The telescopic drawbar 29 can be locked on the guide bar 42 and to be precise in this case by means of two socket pins 33; and the guide bar 42 is fixed via mounting plates 63 to the working device 1, in this case on the crane tower section 9a.

The fifth wheel load plate 30 is joined under the guide bar 28 for example by welding and the pin 31 is mounted, e.g. bolted, on this fifth wheel load plate 30 so that the working device 1 can be connected as a result with the fifth wheel to a lorry or a semi-trailer tractor, after the telescopic drawbar 29 has been brought into the retracted position and locked in this by means of the socket pins 33.

The working device 1, in this case the building crane, is supported by means of outriggers 36, four of which as shown in FIG. 5 are symmetrically arranged centrally, whereby these are preferably designed as hydraulic outriggers which are powered by a hydraulic system 22 (see FIG. 2). These provide—in contrast to the traditional mechanical support spindles—fast automatic levelling by means of an electronic levelling device (not shown) and erection of the working device 1 such as the building crane without the need for a great amount of energy by only a single operator, especially flexible assembly and dismantling on the most difficult terrain or construction site.

As FIGS. 1 and 6 to 11 also show, the wheels 11 of the travelling mechanism are arranged inside the perimeter of the support area of the working device, i.e. here the building crane, that is to say the area which is encompassed by a line connecting the outriggers 36 to each other, whereby it must be ensured that the outriggers 36 can be swung out wide sideways beyond the wheels from the positions shown in FIGS. 7, 9 and 11.

The hydraulic outriggers 36 have an integral pilot-controlled cut off valve and for additional safety are fitted with a check valve on each outrigger 36.

The outriggers 36 are supplied with hydraulic oil by the hydraulic system 22 and can also be individually controlled independently from the automatic electronic levelling device by means of manual control valves 37 (see FIG. 2) which include first control valves 37a for the outriggers on the one side of the travelling mechanism 2 and second control valves 37b for the outriggers on the other side of the travelling mechanism 2 (see FIG. 2). Power is supplied to the hydraulic system 22 when in operation from the switch box of the building crane 1.

In addition, as FIG. 2 shows, connections 57 for supply lines, a main switch 59 and a retaining box 61 are also provided on the chassis 15.

The crane counterweights 35, as FIG. 1 shows, can remain on the retracted building crane 1 during transport.

Finally a foldable outrigger 38 which can be vertically adjusted may be mounted on the crane tower 9, especially the lower crane tower section 9a (FIG. 1) so that it can be removed or folded up in order to support the working device 1 extending far over the travelling mechanism 2, such as the building crane, in the state when this is not attached to a lorry or towing vehicle. This outrigger 38 in FIGS. 6, 8 and 10 has a wheel 39 with which it can also be supported when the working device 1 is being manoeuvred.

The crane 1, depending on the towing vehicle, can be towed as a semi-trailer or as a multiple-axle drawbar trailer.

In addition reference is made to DE 198 56 593 A1 mentioned at the beginning for more different explanations of a travelling mechanism of the basic type with a building crane as shown in FIGS. 1 and 6 to 11, that is to say so far as the changes made by this invention are not concerned.

FIGS. 12 and 13 show a double rocker made available according to the invention, which consists of the longitudinal rocker 5 shown in FIG. 1 and a lateral rocker 121 integral with it which enables the crane 1 or another working device provided instead of this to be inclined across the direction of travel and thus to be driven and manoeuvred with the chassis 15 more easily on difficult terrain. FIG. 12 shows the structure across the direction of travel (i.e. a view on a level which runs vertically to the direction of travel) and FIG. 13 shows the structure in the direction of travel (i.e. a view which corresponds to FIGS. 1, 6, 8 and 10).

The lateral rocker 121 with its rocker bearings 122 is mounted on the longitudinal rocker 5 which can be attached by adjustment and fixing devices 123 which are preferably designed as hydraulic devices (piston-cylinder devices) in its lateral inclination with regard to the longitudinal rocker 5, since the adjustment and fastening devices 123 are mounted via articulated joints 124 on the one hand on the lateral rocker 121 and on the other hand on the longitudinal rocker 5. The longitudinal rocker can be freely pivoted on its rocker bearings 125, whereby its angle of inclination is determined by the outrigger 38 or attachment of a towing vehicle onto the coupling system 28 (see FIGS. 1, 6, 8 and 10).

The lateral rocker 121 therefore enables the crane to be inclined laterally with regard to the travelling mechanism 15 (which is only indicated schematically in FIGS. 12 and 13 through its upper side) in order to move its point of gravity sideways and so that it can be easily manoeuvred even in difficult terrains such as for example on sideways sloping and/or hilly wood and forest tracks (e.g. hairpin bends) or can be easily driven in other ways. Instead of the multiple wheels shown in the figures of the drawing, individual wheels with wide tyres can be provided to improve manoeuvrability and drivability under such conditions even more.

1. Travelling mechanism with a chassis (15) which is provided with at least one wheel axle (3, 4; 110; 113, 114; 116, 117, 118) and wheels (11; 111; 115; 119) and on which a working device (1) is mounted, which is horizontally overhanging at least in the transport position so that it has a large overhang beyond the point of gravity of the travelling mechanism, as a result of which the manoeuvrability of the working device (1) positioned on the travelling mechanism in the transport position is difficult or impossible at the place of erection under confined conditions, whereby
a) the working device (1) positioned on the travelling mechanism in the transport position during manoeuvring can be horizontally turned with regard to the chassis (15) and can be fixed with regard to the chassis (15) in two or more different turning positions,
and/or
b) the working device (1) is mounted on the chassis (15) via a double rocker (5, 121) which includes a lateral rocker (122) which allows the working device (1) to be inclined across the direction of travel and can be locked in its inclined position with regard to the longitudinal rocker (5).

2. Travelling mechanism according to claim 1, characterised in that the chassis has two or more wheel axles (3, 4, 116, 117, 118) whereby
(a) the wheels (11a, 11b; 119) of the individual wheel axles (3, 4, 116, 117, 118) are provided with bogie or axle pivot steering; and
(b) the bogie or axle pivot steering of the wheels (11a, 11b, 119) of the individual wheel axles (3, 4, 116, 117, 118) are connected with each other in such a way that the wheels (11a, 11b, 119) and the wheel axles (3, 4, 116, 117, 118) are synchronously steered in a geometric way.

3. Travelling mechanism according to claim 1, characterised in that the chassis (15) has a single wheel axle (110) mounted rigidly or steerably on the chassis (15).

4. Travelling mechanism according to claim 1, characterised in that the chassis (15) has a plurality of wheel axles, whereby one wheel axle or several or all wheel axles is or are mounted rigidly on the chassis (15).

5. Travelling mechanism according to one of the above claims, characterised in that the steering of the wheel axles (3, 4, 110, 113, 114, 116, 117, 118) can be temporarily uncoupled and/or locked.

6. Travelling mechanism according to one of claims 1 to 5, characterised in that the working device (1) during manoeuvring can be turned with regard to the chassis (15) horizontally by a mechanical drive within a predetermined angle range and can be locked by the mechanical drive and/or separately.

7. Travelling mechanism according to claim 6, characterised in that the working device (1) during manoeuvring can be horizontally turned infinitely variably with regard to the chassis by a mechanical drive within a predetermined angle range and can be locked by the mechanical drive and/or separately.

8. Travelling mechanism according to one of claims 1 to 7, in combination with a working device (1), characterised in that the working device (1) is a building crane, especially a bottom slewing building crane.

9. Travelling mechanism according to one of the above claims, characterised in that the horizontal rotatability of the working device (1) with regard to the chassis (15) is created during manoeuvring by the fact that a rotational locking device (100) provided in the retracted state of the working device (1) between one or the upper and lower base (7, 8) of the working device (1) can be unlocked and can be fixed in two or more different relative turning positions between the upper and lower base (7, 8).

10. Travelling mechanism according to claim 9, characterised in that the rotational locking device (100) has at least one locking pin (101) which can be inserted into apertures or recesses (103a, 103b, 103c; 105) in each case aligned with one another in the upper and lower base (6, 8).

11. Travelling mechanism according to claim 10, characterised in that the one opening (105) is formed in a bracket (102) provided on the upper base (8), which can be mounted aligned in each case with one of a number of openings (103, 103b, 103c) or recesses in the lower base (6) by turning the upper base (8) with regard to the lower base (6).

12. Travelling mechanism according to one of claims 6 to 11, characterised in that the mechanical drive has an adjustment device to turn one or the upper base (8) with regard to one or the lower base (7) which can be operated from the chassis (15) and/or a towing vehicle and/or any other position.

13. Travelling mechanism according to claim 12, characterised in that the adjustment device is to turn one or the upper base (8) with regard to one or the lower base (7).

14. Travelling mechanism according to claims 12 or 13, characterised in that the adjustment device can be locked from the chassis (15) and /or a towing vehicle and/or any other position.

15. Travelling mechanism according to one of claims 6 to 14, characterised in that the mechanical drive includes a hydraulic, compressed air or electric motor and/or a hand crank.

16. Travelling mechanism according to one of the above claims whereby the chassis (15) has a single axle, characterised in that the chassis (15) is a single axle semi-trailer or single axle central trailer.

17. Travelling mechanism according to claim 16, characterised in that an additional front axle is provided on the front part of the working device (1).

18. Travelling mechanism according to claim 17, characterised in that the front axle additionally provided is designed as a drawbar trailer.

19. Travelling mechanism according to one of the above claims, characterised in that to operate the steering an hydraulic system with hydraulic cylinder, a compressed air system with compressed air cylinder or threaded spindles driven by a hydraulic, compressed air or electric motor and/or hand crank is or are provided.

20. Travelling mechanism according to one of the above claims, characterised in that to control the steering of the wheel axle(s) (3, 4, 110; 113, 114; 116, 117, 118) a hand control valve arrangement, a cable remote control and/or a radio remote control is provided.

21. Travelling mechanism according to one of the above claims characterised in that steering of the wheel axle(s) (3, 4; 110; 113, 114; 116, 117, 118) can be controlled by rods or cable controls from a semi-trailer coupling (31) or drawbar (29) which is mounted in the front part of the working device.

22. Travelling mechanism according to one of the above claims whereby the chassis has multiple-axles, characterised in that the chassis (15) is a multiple-axle semi-trailer or rigid drawbar trailer.

23. Travelling mechanism according to claim 22, characterised in that the chassis (15) is designed with an additional front axle as a drawbar trailer.

24. Travelling mechanism according to one of the above claims, characterised in that the springs of the wheel axle(s) (3, 4: 110; 113, 114; 116, 117, 118) are leaf springs (13) or air springs.

25. Travelling mechanism according to claim 24, characterised in that the springs in the case of multiple-axle chassis (15) are designed as leaf springs with a rocker for displacement compensation or air springs with displacement compensation by the air springs themselves.

26. Travelling mechanism according to one of the above claims, whereby a support with hydraulic support cylinders (36) is provided to erect the working device (1) characterised in that to operate the support, an operating unit (22) connectable to the two phase or three phase mains and/or battery-powered is provided.

27. Travelling mechanism according to claim 26, characterised in that a switchover to the steering unit is provided for emergency operation.

28. Travelling mechanism according to claim 26 or 27, characterised in that additional mechanical locking is provided for the hydraulic support cylinders (36) against accidental movement of the support cylinders (36) apart from hydraulic check valves.

29. Travelling mechanism according to claims 26, 27 or 28, characterised in that the hydraulic support cylinders (36) are provided with a levelling device and can be controlled to allow levelling.

30. Travelling mechanism according to claim 29, characterised in that the levelling device is automatic.

31. Travelling mechanism according to claim 29 or 30, characterised in that the levelling device allows sideways levelling.

32. Travelling mechanism according to one of the above claims, characterised in that a semi-trailer coupling (31) and/or a drawbar (29) is provided as towing device.

33. Travelling mechanism according to claim 32, characterised in that a combination of semi-trailer coupling (31) and drawbar (29) is provided as towing device.
